(19) United States
(12) Patent Application Publication
(10) Pub. No.: US 2026/0267943 A1
(43) Pub. Date: Sep. 10, 2026

(54) MACHINE-LEARNING EXECUTION SECURITY

(71) Applicant: Microsoft Technology Licensing, LLC, Redmond, WA (US)

(72) Inventor: Aditya Vasanth CHALLAPALLY, San Francisco, CA (US)

(21) Appl. No.: 19/072,845

(22) Filed: Mar. 6, 2025

(51) Int. Cl. G06F 21/14; G06F 12/14

(52) U.S. Cl. CPC G06F 21/14; G06F 12/1425

(57) ABSTRACT

This invention provides a system for enhancing the privacy and security of neural networks through dynamic execution trace obfuscation. The system generates randomized computational patterns to mask the actual processing flow during inference and training, preventing information leakage via side-channel attacks. It employs a randomization engine to reorder operations, vary memory access patterns, and introduce timing variations, ensuring mathematical correctness and model performance. The system includes a protection component for monitoring execution patterns and a performance optimization component to balance security and efficiency.

### TECHNICAL FIELD

Embodiments pertain to systems and methods for protecting privacy and security in artificial intelligence systems. Some embodiments relate to dynamic execution trace obfuscation techniques for preventing information leakage and protecting sensitive data during neural network operation while maintaining model performance.

### BACKGROUND

Artificial intelligence (AI) techniques enable computing devices to perform sophisticated processing and pattern recognition. Neural networks, a type of AI, are computational models that can be trained to recognize patterns, make decisions, and solve complex problems across diverse domains. Neural networks achieve their capabilities through a layered architecture that may include input layers, hidden processing layers, and output layers that work together to transform raw data into meaningful results. For example, a typical convolutional neural network (CNN) used for image classification might process input through multiple layers including convolutional layers with multiple filters, pooling layers, and fully connected layers before producing final classifications through a SoftMax output layer.

Recent advances in neural network architectures have enabled powerful generative AI systems, including Large Language Models (LLMs), which can process and generate human-readable text, code, and other content. These generative models represent some of the most complex applications of neural networks, often containing billions of parameters arranged in sophisticated transformer architectures that enable them to understand context and generate appropriate responses. Other applications are found across numerous industries and use cases. In financial services, neural networks process millions of market data points daily to power trading models and financial analytics. In healthcare, these systems enable sophisticated diagnostic AI systems that analyze patient data to support medical decision-making.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a system illustrating the interaction between a computing device and a machine-learning model inference service, according to some examples of the present disclosure.

FIG. 2 illustrates an inference system according to some examples of the present disclosure.

FIG. 3 illustrates a flowchart of a method of obfuscating execution of operations of a machine-learning model during execution of inference tasks, according to some examples of the present disclosure.

FIG. 4 illustrates a block diagram of an example machine upon which any one or more of the techniques discussed herein may be performed, according to some examples of the present disclosure.

### DETAILED DESCRIPTION

Machine-learning AI models are often tasked with processing sensitive and confidential data. Unfortunately, these systems are particularly vulnerable to side-channel attacks that allow adversaries to obtain confidential data by analyzing physical characteristics of the system, such as computation timing, power consumption, and memory accesses. These vulnerabilities create challenges for organizations operating under strict regulatory requirements, particularly in sensitive sectors such as financial services, where trading models process millions of market data points daily and healthcare systems handling protected patient information. Existing protection approaches often rely on fixed masking techniques that may become predictable over time. Additionally, some solutions require specialized hardware modifications that severely limit deployment flexibility and are more expensive.

Disclosed in some examples are systems, methods, and devices which protect AI model privacy through dynamic execution trace obfuscation by generating randomized computational patterns that mask the actual processing flow of neural networks during both inference and training while maintaining model performance and mathematical correctness.

The system builds a computational graph of the AI model to create a map of possible execution paths and memory access patterns. The system then utilizes a dynamic obfuscation schedule that introduces controlled randomness into execution patterns. For example, non-dependent operations are randomly reordered, dummy operations are inserted, delays are introduced (to prevent timing attacks), and memory access patterns are scrambled.

The system includes monitoring techniques to ensure both security and correctness, verifying that obfuscated execution produces mathematically equivalent results to the original model while maintaining protection against side-channel attacks. Additionally, it implements adaptive protection mechanisms that can dynamically adjust security measures based on real-time risk assessment and performance requirements, enabling secure model deployment across diverse hardware platforms.

The system includes several integrated components that independently, or together, provide neural network privacy protection through dynamic execution trace obfuscation. The randomization component one or more of: randomizes the order of independent calculations, modifies how and when the system accesses computer memory, or changes the timing between operations. Another component, the protection component, one or more of: monitors power usage patterns, timing patterns, or memory access patterns during inference execution to scan for patterns that indicate inadequate obfuscation and thus the potential for side channel attacks to leak information. If such patterns are detected, the protection component may notify a performance optimization component. A performance optimization component monitors signals from one or more of the protection component or performance metrics of the system to balance the performance of the operations along with the security.

The technical problem addressed by this invention is the vulnerability of neural networks to side-channel attacks, which can lead to information leakage through observable execution patterns. Traditional protection methods, such as fixed masking techniques, become predictable over time and often require specialized hardware, limiting deployment flexibility and increasing costs. The technical solution provided by this invention is a dynamic execution trace obfuscation system that generates randomized computational patterns to mask the actual processing flow of neural networks. This system employs a randomization engine to reorder operations, vary memory access patterns, and introduce timing variations, ensuring both mathematical correctness and model performance. By integrating real-time monitoring and adaptive protection mechanisms, the solution effectively prevents side-channel attacks while maintaining the flexibility to operate across diverse hardware platforms.

### Randomization Component

The randomization component protects neural network privacy by dynamically modifying how the neural network executes to prevent information leakage through side-channel attacks that might seek to compromise information based upon predictable execution sequences. It does this in three ways: 1.) by modifying the order of calculations; 2.) modifying how and when the system accesses computer memory and 3.) randomizing the timing of the operations.

First, during initialization, the randomization component builds a computational graph of the neural network that includes dependency chains that show which calculations are dependent on other calculations. This creates a comprehensive map of all possible execution paths and memory access patterns where information leakage could occur. Example dependency mapping algorithms include topological sorting, critical path analysis, and data flow analysis. Topological sorting organizes operations in a directed graph so that each operation comes before any operations that depend on it, making it clear which calculations must happen in sequence. Critical path analysis identifies the longest chain of dependent operations that determines the minimum execution time. Data flow analysis tracks how data moves between operations to find where values are produced and consumed. The system can also use static program analysis techniques like control flow graphs and use-define chains to map out exactly how different parts of the neural network depend on each other. This graph is used to identify independent operations that can be processed in a different order without affecting the final computational result.

Next, the obfuscation component generates randomization parameters using a cryptographically secure pseudo-random number generator (CSPRNG), such as a CSPRNG based on ChaCha20. These parameters are generated using a hierarchical randomization structure defined by R=H(Seed|TimeStamp∥ExecutionContext), where H represents a secure hash function, Seed is a random number generator seed, and execution context. Some example seeds may include large prime numbers, a process id, a thread id, a MAC address, a hostname, CPU information, a number generated from an entropy pool, a combination of the previously mentioned seeds, or the like. Execution context refers to the specific computational environment details that make each run of the neural network unique. This includes information like the current model state, the specific hardware configuration being used, active security modes, session identifiers, and request-specific metadata. It may also include environmental variables like current memory allocation maps, cache states, system load information, and thread scheduling parameters. By incorporating these contextual details into the randomization function, the system ensures that even when processing identical inputs across multiple runs, the execution patterns will differ unpredictably. This prevents attackers from correlating multiple executions to identify patterns that might reveal sensitive information about the model or its data.

During runtime execution of the neural network, the component reorders the previously identified independent operations according to the generated randomization parameters. This creates an unpredictable execution sequence while maintaining the mathematical correctness of the neural network computations.

In some examples, the randomization component also inserts decoy operations that perform decoy calculations on decoy data. The timing and type of decoy operations as well as the decoy data may be randomized. In some examples, the decoy operations may include web calls that retrieve web-based data. In some examples, the amount of decoy operations inserted may be a randomization pattern that may have an initial, default value, which may be adjusted up or down by the performance optimization component to increase or decrease security at a cost of performance.

Finally, the obfuscation component introduces random delays between operations to prevent timing-based attacks. For example, if two operations are to be performed in succession, a random delay may be inserted into random pairs of successive operations to obfuscate the type of operation being performed. For example, an attacker may deduce that if a matrix multiply takes 10 microseconds, that if the processor reads data and then writes data 10 microseconds later, that the operation was a matrix multiply. By introducing random delays these types of timing-based deductions become more difficult. The amount of random delays, as well as the timing of such delays may also have an initial, default value, which may be adjusted up or down by the performance optimization component to increase or decrease security at a cost of performance.

By randomizing instructions, inserting decoy operations into the pipeline, and by using decoy memory data, the obfuscation system modifies how and when the processor accesses memory which prevents against memory observation attacks, power-based observation attacks, and timing attacks.

The obfuscation component may also employ memory management techniques to enhance security against side-channel attacks. In some examples, the obfuscation component may partition cache memory into secure and standard regions. This approach allocates protected cache lines for security-critical operations while designating unprotected cache lines for standard computations. By isolating sensitive data from general memory access patterns, the system significantly reduces the risk of information leakage through cache-timing attacks. The obfuscation component further implements vector instructions to access the partitioned cache memory, enabling efficient data handling by loading multiple data components from different cache line offsets simultaneously. Memory accesses are aligned to specified-byte array boundaries, and cache lines are accessed through instructions that span multiple regions, ensuring both security and performance are maintained.

Additionally, the obfuscation component may utilize vector instructions for parallel memory access, aligning memory accesses to cache-line boundaries, and performing bulk data transfers at cache-line granularity. This method optimizes the use of available memory bandwidth, allowing the system to handle large volumes of data efficiently while upholding robust security measures. The implementation of vector instructions involves identifying data elements that can be loaded in parallel, calculating aligned memory offsets for vector loads, and executing simultaneous loads across multiple cache lines. These techniques not only enhance the system's ability to obscure memory access patterns but also improve the overall efficiency of data processing, making the obfuscation component a powerful tool for protecting neural network operations against sophisticated side-channel attacks.

### Protection Component

The protection component monitors execution of the model during operation, such as during model inference calculations, looking for predictable patterns that could present opportunities for side channel attacks. The protection component monitors power consumption and/or memory accesses.

To monitor power consumption, the system may utilize a plurality of mechanisms. First, the power sampling component may detect vulnerabilities by capturing microsecond-level variations in power consumption across multiple power domains. When sampling at 1-10 MHz (or up to 50 MHz during suspected attacks), it can identify minute power fluctuations that may indicate an attack. For example, if an attacker attempts to extract information about neural network operations through power analysis, unusual variations in power consumption across CPU cores or memory subsystems can be detected through the parallel sampling channels. These samples may be compared with baseline samples taken with model inferences that are performed without protection.

The continuous wavelet transform (CWT) component identifies potential attacks by analyzing power consumption waveforms in real-time. The system may dynamically switch between different wavelet types to detect specific attack patterns: Morlet wavelets detect unusual frequency patterns that may indicate systematic power analysis attacks; Mexican hat wavelets identify sudden power spikes that could signal targeted probing attempts; Daubechies wavelets detect sharp transitions that might reveal unauthorized operations; Custom wavelets specifically look for known attack signatures in the power consumption patterns.

The multi-scale statistical analysis component detects vulnerabilities through comprehensive analysis across multiple time windows. In the temporal domain, it uses exponentially weighted moving averages with adaptive α to track power consumption trends, while local variance estimation and peak-to-average power ratios identify suspicious power usage patterns. In the frequency domain, it analyzes spectral entropy and power density to detect periodic patterns that could indicate systematic attacks. The system employs advanced pattern recognition through: dynamic time warping to identify similar but time-shifted attack patterns; Hidden Markov Models to detect suspicious state sequences; isolation forests to identify anomalous power consumption; and/or online learning algorithms that continuously adapt to new attack patterns.

The memory monitoring component uses one or more of three components to detect potential vulnerabilities in execution. The probabilistic state machine component detects potential vulnerabilities by analyzing transition probabilities between memory accesses. When the system observes unusual transitions in the Markov chain models (P_1 and P_2 matrices), it can indicate an attack attempting to exploit predictable memory access patterns. The Markov chain models (P_1 and P_2 matrices) track how memory gets accessed during normal operations. The system first watches the neural network during safe, normal runs to learn which memory locations typically get accessed after others. It records these patterns as probability tables (the P_1 and P_2 matrices). Once these normal patterns are established, the system continuously monitors actual memory usage during operation. If it sees unusual jumping between memory addresses that doesn't match the expected patterns, this suggests someone might be trying to attack the system. For example, if memory addresses that rarely get accessed suddenly show high activity, or if the system starts accessing memory in unusual step patterns (strides) compared to normal operation, these could be signs of an attack trying to extract sensitive information. For example, if the temporal locality scores show unexpected spikes in access frequency for specific memory addresses, or if the stride patterns deviate from established baselines, these could indicate attempts to extract sensitive information through memory access analysis.

The cache analysis component identifies vulnerabilities by maintaining comprehensive access distribution profiles D(s) for each cache set. By monitoring temporal characteristics like access frequency distributions and cache line lifetime statistics, along with spatial characteristics such as page-level access patterns and cross-set correlations, the system can detect suspicious cache usage patterns. For instance, unusually high set conflict rates or abnormal replacement patterns could indicate a cache timing attack attempting to extract information about the neural network's operations.

The entropy-based analysis component predicts vulnerabilities by calculating multiple entropy measures (Shannon, Rényi, and Conditional) across different dimensions of memory usage. When these entropy calculations show significant deviations from normal patterns—such as unexpectedly low entropy in address space access (indicating more predictable patterns) or unusual temporal entropy values—this can indicate an attacker attempting to exploit deterministic memory access patterns. The system specifically monitors entropy across address space, temporal patterns, transitions, and joint entropy across multiple channels to provide comprehensive detection of potential security threats. For example, if the conditional entropy H(X|Y) shows strong correlations between certain memory access patterns, this could indicate an attacker has successfully created a predictable sequence of memory operations that could be exploited to extract sensitive information. In some examples, these patterns may be detected by pattern matching algorithms such as threshold-based methods (e.g., if the entropy exceeds the threshold an alert is generated), outlier detection, clustering algorithms (e.g., expectation-maximization)), time-series analysis, and the like.

Any indications of a power or memory pattern that could indicate a potential attack may be sent to the performance optimization component.

### Performance Optimization Component

The performance optimization component monitors execution performance and any attack indications from the protection component and adjusts protection based upon the security constraints (e.g., how sensitive the data is), performance requirements, resource limitations, and system stability conditions. The performance optimization may adjust sampling rate of the protection component, adjust protection parameters, and the like. Protection parameters may include the randomization frequency, frequency of added instructions, frequency and time of added delays, and the like. The performance optimization component may operate using one or more policies and one or more rules that prioritize performance and/or security. For example, the policy may desire maximum security at a particular performance level. The performance optimization component may adjust the security until the performance level is met. In other examples, the policy may indicate that security is to take priority over performance. In these examples, the system may adjust the security parameters without regard for performance.

In some examples, the performance optimization component may have a verification component that ensures that the obfuscation of execution traces does not compromise the mathematical correctness of neural network operations. This component verifies that the scrambled operations produce results equivalent to those of the original execution order to ensure the integrity and reliability of the machine-learning model's outputs. In some examples, the verification component employs a computational correctness check, which involves comparing the output values and intermediate states of the obfuscated execution against reference computations. The reference computations work by saving important values at specific points in the neural network rather than recalculating everything twice. During initial setup, the system runs the neural network normally and saves the correct output values at key checkpoints throughout the network's layers. These saved values become the “reference” values that represent correct operation. Later, when the neural network runs with the security measures active (scrambled operations), the system compares the actual values produced at those same checkpoints against the saved reference values. If the differences stay within acceptable limits, this confirms the scrambled operations are still producing mathematically correct results. This approach verifies correctness without the performance penalty of running the entire neural network calculation twice. This is achieved by sequentially computing reference values for each layer of the neural network and calculating numerical differences between these reference outputs and the actual outputs generated by the scrambled operations. The system ensures that these differences remain within defined tolerance thresholds, thereby confirming that the obfuscation has not altered the intended computational results.

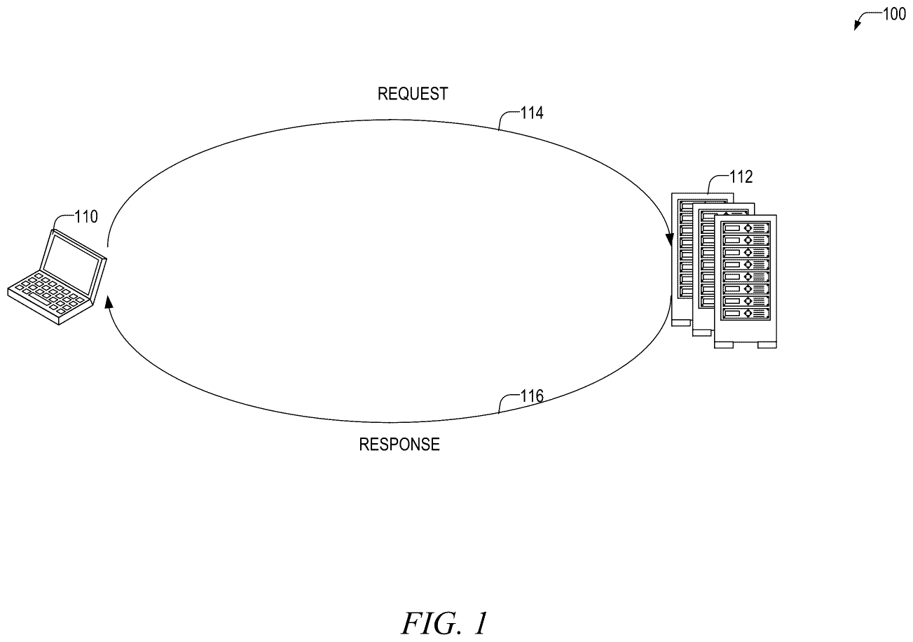

FIG. 1 shows a system 100 illustrating the interaction between a computing device 110 and a machine-learning model inference service 112. This system exemplifies the process of sending an inference request 114 from the computing device 110 to the inference service 112 and receiving an inference response 116 back from the service.

The computing device 110 serves as the user interface for initiating the inference request 114. This device could be any form of computing hardware, such as a personal computer, smartphone, or tablet, equipped with the necessary software to generate and send requests to the inference service 112. The computing device 110 serves as the entry point for data that requires processing by the machine-learning model inference service 112.

The machine-learning model inference service 112 is a network-based service that processes the inference request 114. This service may be hosted on a server or a cluster of servers capable of handling multiple requests simultaneously. The inference service 112 utilizes a previously trained machine-learning model 220 to analyze the input data contained in the inference request 114 and generate a corresponding inference response 116. The service is designed to efficiently manage computational resources to provide timely and accurate responses.

The inference request 114 represents the data or query sent from the computing device 110 to the inference service 112. This request contains the information needed for the machine-learning model 220 to perform its analysis, such as input data and any specific parameters required for processing. The inference response 116 is the output generated by the inference service 112 after processing the inference request 114. This response is sent back to the computing device 110 and contains the results of the machine-learning model's analysis. The inference response 116 is structured to provide clear and actionable insights based on the input data, enabling the computing device 110 to utilize this information for further decision-making or user interaction.

The machine-learning model inference service 112 may provide responses for a diverse array of inference tasks, leveraging neural network or other machine-learning architectures to deliver responses across various domains. Such inference tasks include image creation, where the service can generate realistic images from textual descriptions or enhance existing images through techniques such as super-resolution and style transfer. This capability is particularly useful in fields like digital art, advertising, and content creation, where visual content plays a crucial role.

In addition to image-related tasks, inference tasks may include natural language processing applications, such as question and answer (Q&A) systems. By utilizing large language models, the service can understand and respond to complex queries with contextually relevant and accurate answers. This functionality may find application in customer support, educational platforms, and virtual assistants.

The inference service also supports a wide range of writing tasks, including content generation, summarization, and translation. By analyzing input text, the service can produce coherent and contextually appropriate written content, aiding in tasks such as drafting articles, creating marketing copy, or translating documents between languages.

Furthermore, the inference service can be employed in specialized domains such as medical diagnostics, where it assists in analyzing medical images and patient data to provide diagnostic insights. In financial services, the service can process vast amounts of market data to generate trading signals or risk assessments. These domain-specific applications demonstrate the service's adaptability and potential to drive innovation across various industries by providing intelligent, data-driven solutions.

While FIG. 1 illustrates the inference service 112 as a network-based service, computing device 110 may also include functionality to process the inference request 114 locally. In scenarios where network connectivity is limited or where data privacy is a primary concern, the computing device 110 may leverage its own computational resources to perform inference tasks. This local processing capability may be particularly beneficial for applications that require immediate responses or operate in environments with stringent data security regulations. By processing inference requests locally, the computing device 110 can ensure that sensitive data remains on-premises, reducing the risk of data exposure during transmission.

Local processing also offers advantages in terms of latency and bandwidth usage. By eliminating the need to send data over a network, the computing device 110 can achieve faster response times, which is crucial for real-time applications such as augmented reality, autonomous systems, and interactive user interfaces. Additionally, local processing reduces the dependency on network bandwidth, making it suitable for use in remote or bandwidth-constrained environments.

The inference system of FIG. 1 may utilize the disclosed techniques to secure the inference process from side-channel attacks that may compromise data, either data used in the inference task, or model data.

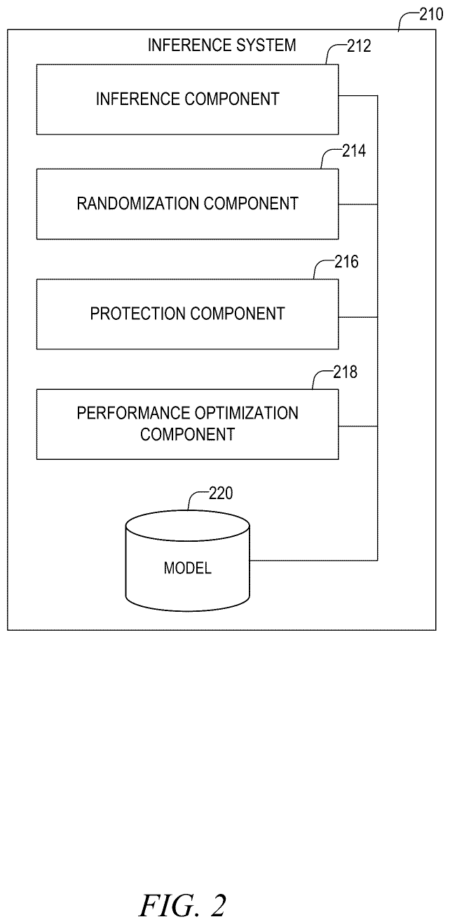

FIG. 2 illustrates an inference system 210, which may serve as an example of an inference service 112, according to some examples of the present disclosure. The inference system 210 is designed to enhance the security and efficiency of neural network operations. The inference system 210 may integrate an inference component 212, a randomization component 214, a protection component 216, and a performance optimization component 218, along with a machine-learning model 220.

An inference component 212 is responsible for processing inference requests and generating responses based on a previously trained machine-learning model 220. This component executes the primary functionality of the inference system 210, by transforming input data into meaningful output. The remaining components work with the inference component 212 to secure the process of creating responses to inference requests.

A randomization component 214 is included to protect the neural network's execution trace by introducing variability in the computational patterns. This component dynamically modifies the order of operations, memory access patterns, and timing intervals to prevent side-channel attacks, thereby safeguarding sensitive information from being inferred through execution analysis.

A protection component 216 monitors the inference system's operations to detect potential vulnerabilities. The component analyzes power usage, memory access, and timing patterns to identify any predictable sequences that could be exploited by attackers. Upon detecting such patterns, the protection component 216 can trigger adjustments in the randomization component 214 to enhance security measures.

A performance optimization component 218 ensures that the inference system 210 maintains a balance between security and performance. The component continuously monitors the system's performance metrics and adjusts the protection component 216 accordingly. This component plays a significant role in optimizing the system's efficiency, particularly in resource-constrained environments, by dynamically tuning the level of obfuscation based on current operational demands and threat levels.

The machine-learning model 220 represents the neural network or other machine learning model utilized by the inference component 212 to process data. The model is stored in a database and accessed during inference operations. While the present disclosure may refer to the model as a neural network, a person of ordinary skill in the art will appreciate that the techniques of the present disclosure may apply to other types of models.

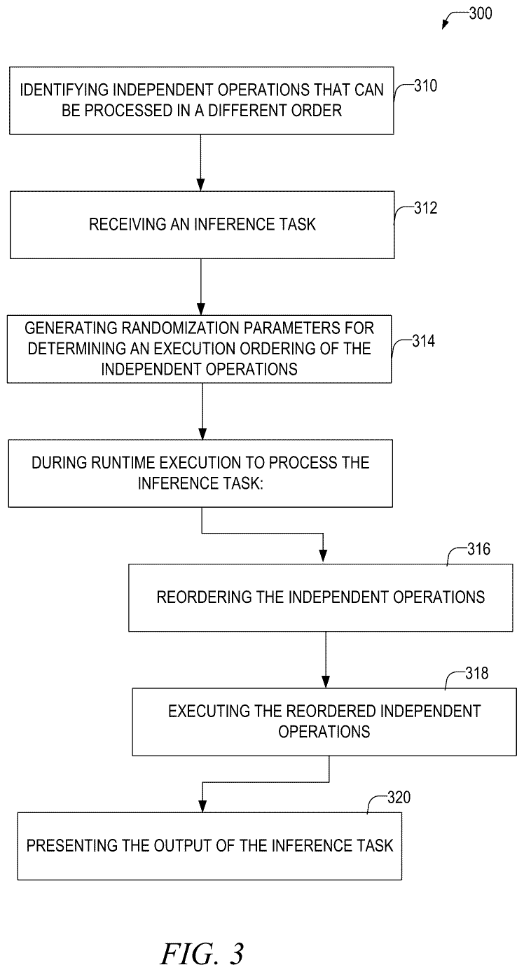

FIG. 3 illustrates a flowchart of a method 300 for obfuscating the execution of operations of a machine-learning model during the execution of inference tasks according to some examples of the present disclosure. At operation 310, the method begins by identifying independent operations within the machine-learning model that can be processed in a different order without affecting the final computational result. Operation 312 involves receiving an inference task. This task comprises input data that needs to be processed by the machine-learning model. The inference task is typically received from a requestor, which could be a user or another system component requiring the model's output.

Following the receipt of the inference task, at operation 314 the system generates randomization parameters. The randomization parameters are generated using a pseudo-random number generator. The randomization parameters a set of one or more values generated to control various aspects of the execution sequence of a machine-learning model. The randomization parameters may include one or more of: an instruction sequence order, timing variability parameters, memory access parameters, and decoy operation parameters. These parameters include execution order parameters that determine the sequence in which independent operations are executed. By altering the order of operations that do not depend on each other, the system can create an unpredictable execution path. Other parameters may include timing variability parameters that specify how random delays are introduced between operations. By varying the timing of operations, the system can prevent timing-based side-channel attacks. Still additional parameters may include memory access parameters that control how and when memory is accessed during execution. By randomizing memory access patterns, the system can obscure the data flow and prevent correlation analysis. Still yet additional parameters may include decoy operations parameters that determine the insertion of dummy operations and the use of decoy data. By adding non-essential operations, the system can further obfuscate the actual computational flow.

The randomization parameters may be generated, at least in part, using a cryptographically secure pseudo-random number generator (CSPRNG) and may be defined by:
R=H(Seed∥TimeStamp∥ExecutionContext)
where
H represents a secure hash function,
Seed is a random number generator seed, and
ExecutionContext includes various contextual information such as the specific hardware being used, which processor cores are active, current memory usage patterns, which other programs are running, security settings, and unique session identifiers. These details capture the state of the system at the moment the model runs, like taking a snapshot of all the computing conditions. By including this information, the system ensures that each time the neural network processes data—even the same data multiple times—it follows a different execution path. This makes it extremely difficult for attackers to predict or analyze how the system is working, similar to how changing your route to work each day would make it hard for someone to track your movements.

During runtime execution to process the inference task, operation 316 involves reordering the independent operations according to the generated randomization parameters. This reordering creates an unpredictable execution sequence while maintaining the mathematical correctness of computations of the machine-learning model. For example, the randomization parameters may be a sequence of randomly selected numbers that identifies the instruction orders and operation 316 orders the instructions according to the instruction orders. In other examples, the randomization parameters may be a random number and operation 316 involves using that random number to scramble the operations (e.g., by utilizing a shuffling algorithm such as a Knuth or Fisher-Yates shuffle on an array or other data structure storing the operations).

At operation 318, the reordered independent operations are executed on the input data. This execution step is where the actual processing of the inference task occurs, with the reordered operations generating distinct execution traces for each model operation.

Finally, operation 320 presents the output of the inference task to the requestor. This output is the result of the machine-learning model's analysis of the input data, delivered in a manner that ensures the obfuscation process has not compromised the integrity or accuracy of the results. In some examples, this operation includes transmitting the output to the requestor, displaying the output on a display, or the like.

The disclosed obfuscation techniques are designed to address the diverse needs of various industries, ensuring robust data privacy and security without compromising performance. In the financial services sector, for instance, the system can be deployed to protect proprietary trading models and sensitive financial data processing systems. High-frequency trading environments, which require both security and minimal latency, may benefit significantly from this implementation. The obfuscation system operates with minimal overhead while making side-channel attacks that could potentially reconstruct trading strategies through power consumption analysis more difficult.

In the healthcare industry, the system can be implemented to safeguard patient data privacy within diagnostic AI systems. Given the strict regulatory compliance requirements, such as HIPAA, the system's ability to prevent information leakage is crucial. By creating distinct protection profiles for different types of patient data, the obfuscation system ensures that execution traces cannot be used to identify individual patients or reconstruct sensitive data. This implementation not only enhances privacy protection but also maintains the accuracy and reliability of diagnostic models, providing healthcare providers with a secure and compliant solution for handling patient information.

For edge devices, such as smartphones and IoT devices, the system offers a flexible solution that adapts to varying computational capabilities and resource constraints. Mobile device manufacturers can deploy the system to protect AI models running on smartphone processors, dynamically adjusting protection levels based on device state and application requirements. This ensures that security guarantees are maintained without significantly impacting battery life or performance. By providing robust protection in resource-constrained environments, the system enables secure AI model execution across a wide range of devices, from cloud servers to edge devices, supporting applications that require both privacy and efficiency.

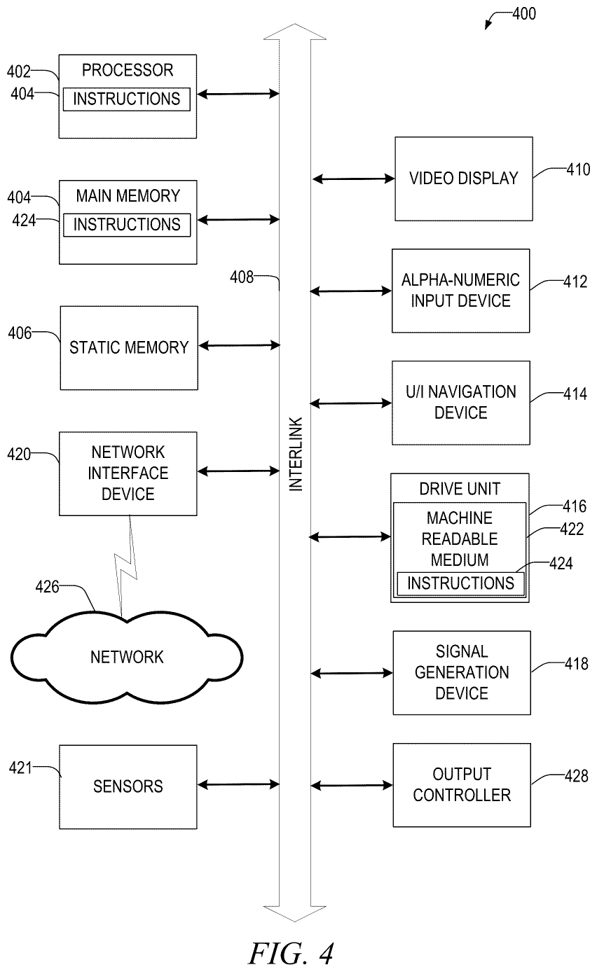

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

### Other Notes and Examples

Example 1 is a method for obfuscating execution of operations of a machine-learning model during execution of inference tasks, the method comprising: receiving, by a processor, an inference task comprising input data to be processed by the machine-learning model, the inference task received from a requestor; creating, by the processor, a computational graph mapping execution dependency of the machine-learning model by representing input-dependent operations as nodes and specifying data flow paths between nodes as edges, the computational graph created based on a model architecture of the machine-learning model; identifying, by the processor, and based upon the computational graph, independent operations within the machine-learning model that are performed during the inference task that can be processed in a different order without changing an output of the inference task; generating, by the processor, using a pseudo-random number generator, randomization parameters for determining an execution order of the independent operations within the machine-learning model that are performed during the inference task; ordering, by the processor, the independent operations within the machine-learning model that are performed during the inference task according to the randomization parameters to create a reordered independent operations of the independent operations within the machine-learning model that are performed during the inference task; and executing, by the processor, the reordered independent operations on the input data to produce an output of the inference task, the reordered independent operations generating randomized execution traces for each inference task of the machine-learning model; and transmitting, by the processor, the output of the inference task to the requestor.

In Example 2, the subject matter of Example 1 includes, verifying, by the processor, that the reordered independent operations produces mathematically equivalent results to an original execution order while maintaining random execution sequences.

In Example 3, the subject matter of Example 2 includes, wherein verifying mathematical that the reordered independent operations produces mathematically equivalent results comprises: comparing output values and intermediate states during execution of the reordered independent operations against reference computations by: sequentially computing reference values for each layer of the machine-learning model; calculating numerical differences between reference and actual outputs; and validating that differences remain within defined tolerance thresholds.

In Example 4, the subject matter of Examples 1-3 includes, calculating entropy measurements of execution patterns of the reordered independent operations; applying pattern recognition algorithms to detect statistical regularities in the execution patterns; and generating alerts when pattern recognition detects patterns.

In Example 5, the subject matter of Examples 1-4 includes, monitoring execution performance metrics during execution of the reordered independent operations; determining whether the performance metrics indicated performance below a threshold level of performance; and in response, reducing protection mechanisms by decreasing a randomization frequency.

In Example 6, the subject matter of Examples 1-5 includes, partitioning a cache memory into secure and standard regions by: allocating protected cache lines for security-critical operations; and designating unprotected cache lines for standard computations; implementing vector instructions to access the partitioned cache memory by: loading multiple data components from different cache line offsets simultaneously; aligning memory accesses to specified-byte array boundaries; and accessing cache lines through instructions that span multiple regions; and managing data movement between cache regions by: scanning arrays at cache-line granularity rather than element-level; loading security-critical data into protected cache lines; and serving subsequent reads from processor core's private cache.

In Example 7, the subject matter of Examples 1-6 includes, wherein executing, by the processor, the reordered independent operations on the input data to produce an output of the inference task comprises: utilizing vector instructions for parallel memory access; aligning memory accesses to cache-line boundaries; and performing bulk data transfers at cache-line granularity.

In Example 8, the subject matter of Example 7 includes, wherein utilizing vector instructions comprises: identifying data elements that can be loaded in parallel; calculating aligned memory offsets for vector loads; and executing simultaneous loads across multiple cache lines.

Example 9 is a computing device for obfuscating execution of operations of a machine-learning model during execution of inference tasks, the computing device comprising: a hardware processor; a memory, the memory storing instructions, which when executed by the hardware processor cause the computing device to perform operations comprising: receiving an inference task comprising input data to be processed by the machine-learning model, the inference task received from a requestor; creating a computational graph mapping execution dependency of the machine-learning model by representing input-dependent operations as nodes and specifying data flow paths between nodes as edges, the computational graph created based on a model architecture of the machine-learning model; identifying, based upon the computational graph, independent operations within the machine-learning model that are performed during the inference task that can be processed in a different order without changing an output of the inference task; generating, using a pseudo-random number generator, randomization parameters for determining an execution order of the independent operations within the machine-learning model that are performed during the inference task; ordering the independent operations within the machine-learning model that are performed during the inference task according to the randomization parameters to create a reordered independent operations of the independent operations within the machine-learning model that are performed during the inference task; executing the reordered independent operations on the input data to produce an output of the inference task, the reordered independent operations generating randomized execution traces for each inference task of the machine-learning model; and transmitting the output of the inference task to the requestor.

In Example 10, the subject matter of Example 9 includes, wherein the operations further comprise: verifying that the reordered execution produces mathematically equivalent results to an original execution order while maintaining random execution sequences.

In Example 11, the subject matter of Example 10 includes, wherein the operation of verifying that the reordered execution produces mathematically equivalent results comprises: comparing output values and intermediate states during execution of the reordered independent operations against reference computations by: sequentially computing reference values for each layer of the machine-learning model; calculating numerical differences between reference and actual outputs; and validating that differences remain within defined tolerance thresholds.

In Example 12, the subject matter of Examples 9-11 includes, wherein the operations further comprise: calculating entropy measurements of execution patterns of the reordered independent operations; applying pattern recognition algorithms to detect statistical regularities in the execution patterns; and generating alerts when pattern recognition detects patterns.

In Example 13, the subject matter of Examples 9-12 includes, wherein the operations further comprise: monitoring execution performance metrics during execution of the reordered independent operations; determining whether the performance metrics indicated performance below a threshold level of performance; and in response, reducing protection mechanisms by decreasing a randomization frequency.

In Example 14, the subject matter of Examples 9-13 includes, wherein the operations further comprise: partitioning a cache memory into secure and standard regions by: allocating protected cache lines for security-critical operations; and designating unprotected cache lines for standard computations; implementing vector instructions to access the partitioned cache memory by: loading multiple data components from different cache line offsets simultaneously; aligning memory accesses to specified-byte array boundaries; and accessing cache lines through instructions that span multiple regions; and managing data movement between cache regions by: scanning arrays at cache-line granularity rather than element-level; loading security-critical data into protected cache lines; and serving subsequent reads from processor core's private cache.

In Example 15, the subject matter of Examples 9-14 includes, wherein the operation of executing the reordered independent operations on the input data to produce an output of the inference task comprises: utilizing vector instructions for parallel memory access; aligning memory accesses to cache-line boundaries; and performing bulk data transfers at cache-line granularity.

In Example 16, the subject matter of Example 15 includes, wherein the operation of utilizing vector instructions comprises: identifying data elements that can be loaded in parallel; calculating aligned memory offsets for vector loads; and executing simultaneous loads across multiple cache lines.

Example 17 is a non-transitory machine-readable medium, storing instructions for obfuscating execution of operations of a machine-learning model during execution of inference tasks, the instructions, which when executed, cause the machine to perform operations comprising: receiving an inference task comprising input data to be processed by the machine-learning model, the inference task received from a requestor; creating a computational graph mapping execution dependency of the machine-learning model by representing input-dependent operations as nodes and specifying data flow paths between nodes as edges, the computational graph created based on a model architecture of the machine-learning model; identifying, based upon the computational graph, independent operations within the machine-learning model that are performed during the inference task that can be processed in a different order without changing an output of the inference task; generating, using a pseudo-random number generator, randomization parameters for determining an execution order of the independent operations within the machine-learning model that are performed during the inference task; ordering the independent operations within the machine-learning model that are performed during the inference task according to the randomization parameters to create a reordered independent operations of the independent operations within the machine-learning model that are performed during the inference task; executing the reordered independent operations on the input data to produce an output of the inference task, the reordered independent operations generating randomized execution traces for each inference task of the machine-learning model; and transmitting the output of the inference task to the requestor.

In Example 18, the subject matter of Example 17 includes, wherein the operations further comprise: verifying that the reordered execution produces mathematically equivalent results to an original execution order while maintaining random execution sequences.

In Example 19, the subject matter of Example 18 includes, wherein the operation of verifying that the reordered execution produces mathematically equivalent results comprises: comparing output values and intermediate states during execution of the reordered independent operations against reference computations by: sequentially computing reference values for each layer of the machine-learning model; calculating numerical differences between reference and actual outputs; and validating that differences remain within defined tolerance thresholds.

In Example 20, the subject matter of Examples 17-19 includes, wherein the operations further comprise: calculating entropy measurements of execution patterns of the reordered independent operations; applying pattern recognition algorithms to detect statistical regularities in the execution patterns; and generating alerts when pattern recognition detects patterns.

In Example 21, the subject matter of Examples 17-20 includes, wherein the operations further comprise: monitoring execution performance metrics during execution of the reordered independent operations; determining whether the performance metrics indicated performance below a threshold level of performance; and in response, reducing protection mechanisms by decreasing a randomization frequency.

In Example 22, the subject matter of Examples 17-21 includes, wherein the operations further comprise: partitioning a cache memory into secure and standard regions by: allocating protected cache lines for security-critical operations; and designating unprotected cache lines for standard computations; implementing vector instructions to access the partitioned cache memory by: loading multiple data components from different cache line offsets simultaneously; aligning memory accesses to specified-byte array boundaries; and accessing cache lines through instructions that span multiple regions; and managing data movement between cache regions by: scanning arrays at cache-line granularity rather than element-level; loading security-critical data into protected cache lines; and serving subsequent reads from processor core's private cache.

In Example 23, the subject matter of Examples 17-22 includes, wherein the operation of executing the reordered independent operations on the input data to produce an output of the inference task comprises: utilizing vector instructions for parallel memory access; aligning memory accesses to cache-line boundaries; and performing bulk data transfers at cache-line granularity.

In Example 24, the subject matter of Example 23 includes, wherein the operation of utilizing vector instructions comprises: identifying data elements that can be loaded in parallel; calculating aligned memory offsets for vector loads; and executing simultaneous loads across multiple cache lines.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

What is claimed is:

1. A method for obfuscating execution of operations of a machine-learning model during execution of inference tasks, the method comprising:
receiving, by a processor, an inference task comprising input data to be processed by the machine-learning model, the inference task received from a requestor;
creating, by the processor, a computational graph mapping execution dependency of the machine-learning model by representing input-dependent operations as nodes and specifying data flow paths between nodes as edges, the computational graph created based on a model architecture of the machine-learning model;
identifying, by the processor, and based upon the computational graph, independent operations within the machine-learning model that are performed during the inference task that can be processed in a different order without changing an output of the inference task;
generating, by the processor, using a pseudo-random number generator, randomization parameters for determining an execution order of the independent operations within the machine-learning model that are performed during the inference task;
ordering, by the processor, the independent operations within the machine-learning model that are performed during the inference task according to the randomization parameters to create a reordered independent operations of the independent operations within the machine-learning model that are performed during the inference task;
executing, by the processor, the reordered independent operations on the input data to produce an output of the inference task, the reordered independent operations generating randomized execution traces for each inference task of the machine-learning model; and
transmitting, by the processor, the output of the inference task to the requestor.

2. The method of claim 1, further comprising:
verifying, by the processor, that the reordered independent operations produces mathematically equivalent results to an original execution order while maintaining random execution sequences.

3. The method of claim 2, wherein verifying mathematical that the reordered independent operations produces mathematically equivalent results comprises:
comparing output values and intermediate states during execution of the reordered independent operations against reference computations by:
sequentially computing reference values for each layer of the machine-learning model;
calculating numerical differences between reference and actual outputs; and
validating that differences remain within defined tolerance thresholds.

4. The method of claim 1, further comprising:
calculating entropy measurements of execution patterns of the reordered independent operations;
applying pattern recognition algorithms to detect statistical regularities in the execution patterns; and
generating alerts when pattern recognition detects patterns.

5. The method of claim 1, further comprising:
monitoring execution performance metrics during execution of the reordered independent operations;
determining whether the performance metrics indicated performance below a threshold level of performance; and
in response, reducing protection mechanisms by decreasing a randomization frequency.

6. The method of claim 1, further comprising:
partitioning a cache memory into secure and standard regions by:
allocating protected cache lines for security-critical operations; and
designating unprotected cache lines for standard computations;
implementing vector instructions to access the partitioned cache memory by:
loading multiple data components from different cache line offsets simultaneously;
aligning memory accesses to specified-byte array boundaries; and
accessing cache lines through instructions that span multiple regions; and
managing data movement between cache regions by:
scanning arrays at cache-line granularity rather than element-level;
loading security-critical data into protected cache lines; and
serving subsequent reads from processor core's private cache.

7. The method of claim 1, wherein executing, by the processor, the reordered independent operations on the input data to produce an output of the inference task comprises:
utilizing vector instructions for parallel memory access;
aligning memory accesses to cache-line boundaries; and
performing bulk data transfers at cache-line granularity.

8. The method of claim 7, wherein utilizing vector instructions comprises:
identifying data elements that can be loaded in parallel;
calculating aligned memory offsets for vector loads; and
executing simultaneous loads across multiple cache lines.

9. A computing device for obfuscating execution of operations of a machine-learning model during execution of inference tasks, the computing device comprising:
a hardware processor;
a memory, the memory storing instructions, which when executed by the hardware processor cause the computing device to perform operations comprising:
receiving an inference task comprising input data to be processed by the machine-learning model, the inference task received from a requestor;
creating a computational graph mapping execution dependency of the machine-learning model by representing input-dependent operations as nodes and specifying data flow paths between nodes as edges, the computational graph created based on a model architecture of the machine-learning model;
identifying, based upon the computational graph, independent operations within the machine-learning model that are performed during the inference task that can be processed in a different order without changing an output of the inference task;
generating, using a pseudo-random number generator, randomization parameters for determining an execution order of the independent operations within the machine-learning model that are performed during the inference task;
ordering the independent operations within the machine-learning model that are performed during the inference task according to the randomization parameters to create a reordered independent operations of the independent operations within the machine-learning model that are performed during the inference task;
executing the reordered independent operations on the input data to produce an output of the inference task, the reordered independent operations generating randomized execution traces for each inference task of the machine-learning model; and
transmitting the output of the inference task to the requestor.

10. The computing device of claim 9, wherein the operations further comprise:
verifying that the reordered execution produces mathematically equivalent results to an original execution order while maintaining random execution sequences.

11. The computing device of claim 10, wherein the operation of verifying that the reordered execution produces mathematically equivalent results comprises:
comparing output values and intermediate states during execution of the reordered independent operations against reference computations by:
sequentially computing reference values for each layer of the machine-learning model;
calculating numerical differences between reference and actual outputs; and
validating that differences remain within defined tolerance thresholds.

12. The computing device of claim 9, wherein the operations further comprise:
calculating entropy measurements of execution patterns of the reordered independent operations;
applying pattern recognition algorithms to detect statistical regularities in the execution patterns; and
generating alerts when pattern recognition detects patterns.

13. The computing device of claim 9, wherein the operations further comprise:
monitoring execution performance metrics during execution of the reordered independent operations;
determining whether the performance metrics indicated performance below a threshold level of performance; and
in response, reducing protection mechanisms by decreasing a randomization frequency.

14. The computing device of claim 9, wherein the operations further comprise:
partitioning a cache memory into secure and standard regions by:
allocating protected cache lines for security-critical operations; and
designating unprotected cache lines for standard computations;
implementing vector instructions to access the partitioned cache memory by:
loading multiple data components from different cache line offsets simultaneously;
aligning memory accesses to specified-byte array boundaries; and
accessing cache lines through instructions that span multiple regions; and
managing data movement between cache regions by:
scanning arrays at cache-line granularity rather than element-level;
loading security-critical data into protected cache lines; and
serving subsequent reads from processor core's private cache.

15. The computing device of claim 9, wherein the operation of executing the reordered independent operations on the input data to produce an output of the inference task comprises:
utilizing vector instructions for parallel memory access;
aligning memory accesses to cache-line boundaries; and
performing bulk data transfers at cache-line granularity.

16. The computing device of claim 15, wherein the operation of utilizing vector instructions comprises:
identifying data elements that can be loaded in parallel;
calculating aligned memory offsets for vector loads; and
executing simultaneous loads across multiple cache lines.

17. A non-transitory machine-readable medium, storing instructions for obfuscating execution of operations of a machine-learning model during execution of inference tasks, the instructions, which when executed, cause the machine to perform operations comprising:
receiving an inference task comprising input data to be processed by the machine-learning model, the inference task received from a requestor;
creating a computational graph mapping execution dependency of the machine-learning model by representing input-dependent operations as nodes and specifying data flow paths between nodes as edges, the computational graph created based on a model architecture of the machine-learning model;
identifying, based upon the computational graph, independent operations within the machine-learning model that are performed during the inference task that can be processed in a different order without changing an output of the inference task;
generating, using a pseudo-random number generator, randomization parameters for determining an execution order of the independent operations within the machine-learning model that are performed during the inference task;
ordering the independent operations within the machine-learning model that are performed during the inference task according to the randomization parameters to create a reordered independent operations of the independent operations within the machine-learning model that are performed during the inference task;
executing the reordered independent operations on the input data to produce an output of the inference task, the reordered independent operations generating randomized execution traces for each inference task of the machine-learning model; and
transmitting the output of the inference task to the requestor.

18. The non-transitory machine-readable medium of claim 17, wherein the operations further comprise:
verifying that the reordered execution produces mathematically equivalent results to an original execution order while maintaining random execution sequences.

19. The non-transitory machine-readable medium of claim 18, wherein the operation of verifying that the reordered execution produces mathematically equivalent results comprises:
comparing output values and intermediate states during execution of the reordered independent operations against reference computations by:
sequentially computing reference values for each layer of the machine-learning model;
calculating numerical differences between reference and actual outputs; and
validating that differences remain within defined tolerance thresholds.

20. The non-transitory machine-readable medium of claim 17, wherein the operations further comprise:
calculating entropy measurements of execution patterns of the reordered independent operations;
applying pattern recognition algorithms to detect statistical regularities in the execution patterns; and
generating alerts when pattern recognition detects patterns.
